(19) United States
(12) Patent Application Publication
(10) Pub. No.: US 2023/0224356 A1
(43) Pub. Date: Jul. 13, 2023

(54) ZERO-COPY METHOD FOR SENDING KEY VALUES

(71) Applicant: VMware, Inc., Palo Alto, CA (US)

(72) Inventors: Alex Markuze, Ramat Gan (IL); Chen Dar, Magshimim (IL); Aran Bergman, Givatayim (IL); Igor Golikov, Kfar Saba (IL); Israel Cidon, San Francisco, CA (US); Eyal Zohar, Shimshit (IL)

(21) Appl. No.: 17/574,236

(22) Filed: Jan. 12, 2022

(51) Int. Cl. H04L 67/06; G06F 16/13; G06F 16/182

(52) U.S. Cl. CPC H04L 67/06; G06F 16/13; G06F 16/183

(57) ABSTRACT

The method of some embodiments provides values from a server over a network connection. The method, for each of multiple values (i) creates a file including the value on a random access memory filing system (RAMFS), (ii) receives a request to receive the value, and (iii) sends the file via a sendfile system call.

### BACKGROUND

In the field of computing, data transfers from one computer to another take up a significant amount of computing time. One of the processes that make this problem worse is that in some operations, such as virtual computing, data may need to be accessed by multiple separate processes on a particular physical machine (e.g., a host machine of a datacenter, standalone computer, etc.). In the prior art, different processes may each need their own copy of a set of data. In such circumstances, data used by multiple processes on the same machine will be copied, sometimes multiple times, from one memory location (accessible by a first process) to another memory location (accessible to a second process) on the same machine. Such copying may slow down the transmission and/or processing of the data. For example, in a prior art socket splicing operation, incoming data on a receiving socket is copied from a first memory location used by a receiving socket, to a second, intermediary memory location. The data is then copied from the intermediate memory location to a third memory location used by a transmitting socket. Each additional copy operation slows down the transmission of the data.

In some of the prior art, Berkeley Sockets (a.k.a. BSD sockets) are often used for inter process communication and are the de-facto standard API for I/O (convenient API for user-space I/O). With BSD, splicing TCP sockets requires performing two I/O operations (one read operation and one write operation) per I/O buffer. Additional performance costs include memory copying that consumes several CPU cycles and hurt other processes by “polluting” shared L3 cache and putting additional pressure on the memory channels. The performance costs also include additional system calls and a slow network stack. High-speed Ethernet speeds are reduced by these performance costs of the BSD Sockets because network speeds have outstripped those of the CPU and memory. Thus operations that require extra CPU and memory use become a bottleneck for data transmission. Because the network transmits data faster than a single CPU can feed the data into the network, more than a single CPU core is required to simply saturate a network link.

Attempts have been made to eliminate these performance costs by creating network systems that bypass the kernel of a computer in the network transmission path, such as with DPDK and Netmap. The kernel bypass methods attempt to avoid the performance penalties associated with BSD Sockets. However, by bypassing the kernels, these methods lose the use of network infrastructure that already exists inside the kernel. Without the existing kernel infrastructure, the kernel bypass methods require a substitute for that network. Thus, the developers of such kernel bypass methods also need to re-develop existing network infrastructure of the kernels (e.g., IP, TCP, ICMP, and IGMP). Therefore, there is a need in the art for a dedicated memory allocator for I/O operations that inherently facilitates zero-copy I/O operations and exceptionless system calls rather than merely bypassing the kernel.

### BRIEF SUMMARY

Modern computers use a bifurcated structure that includes a core operating system (the kernel) and applications that access that kernel operating in a user-space. Some data is used by both the kernel and by applications in the user-space. The prior art copies the data from memory locations used by the kernel to separate memory locations used by applications of the user-space. Unlike that prior art, some embodiments provide a novel method for performing zero-copy operations using a dedicated memory allocator for I/O operations (MAIO). Zero-copy operations are operations that allow separate processes (e.g., a kernel-space process and a user-space process, two sockets in a kernel-space, etc.) to access the same data without copying the data between separate memory locations. The term “kernel-space process,” as used herein, encompasses any operation or set of operations by the kernel, including operations that are part of a specific process, operations called by a specific process, or operations independent of any specific process.

To enable the zero-copy operations that share data between user-space processes and kernel-space processes without copying the data, the method of some embodiments provides a user-space process that maps a pool of dedicated kernel memory pages to a virtual memory address space of user-space processes. The method allocates a virtual region of the memory for zero-copy operations. The method allows access to the virtual region by both the user-space process and a kernel-space process. The MAIO system of the present invention greatly outperforms standard copying mechanism and performs at least on par and in many cases better than existing zero-copy techniques while preserving the ubiquitous BSD Sockets API.

In some embodiments, the method only allows a single user to access a particular virtual region. In some embodiments, the allocated virtual region implements a dedicated receiving (RX) ring for a network interface controller (NIC). The dedicated RX ring may be limited to a single tuple (e.g., a single combination of source IP address, source port address, destination IP address, destination port address, and protocol). The dedicated RX ring may alternately be limited to a defined group of tuples.

In the method of some embodiments, the allocated virtual region implements a dedicated transmission (TX) ring for a NIC. Similar to the case in which the virtual region implements an RX ring, the dedicated TX ring may be limited to a single tuple or a defined group of tuples.

The kernel has access to a finite amount of memory. Allocating that memory for use in zero-copy operations prevents the allocated memory from being used for other kernel functions. If too much memory is allocated, the kernel may run out of memory. Accordingly, in addition to allocating virtual memory, the user-space process of some embodiments may also de-allocate memory to free it for other kernel uses. Therefore, the user-space process of some embodiments identifies virtual memory, already allocated to zero-copy operations, to be de-allocated. In some cases, a user-space process may not de-allocate enough memory. Therefore, in some embodiments, when the amount of memory allocated by the user-space process is more than a threshold amount, the kernel-space process de-allocates at least part of the memory allocated by the user-space process. In some embodiments, either in addition to or instead of the kernel-space process de-allocating memory, when the amount of memory allocated by the user-space process is more than a threshold amount, the kernel-space process prevents the user-space process from allocating more memory.

In some embodiments, the kernel-space process is a guest kernel-space process on a guest virtual machine operating on a host machine. The method may additionally allow access to the virtual region by a user-space process of the host machine and/or a kernel-space process of the host.

Zero-copy processes can also be used for TCP splicing. Some embodiments provide a method of splicing TCP sockets on a computing device (e.g., a physical computer or a virtual computer) that processes a kernel of an operating system. The method receives a set of packets at a first TCP socket of the kernel, stores the set of packets at a kernel memory location, and sends the set of packets directly from the kernel memory location out through a second TCP socket of the kernel. In some embodiments, the receiving, storing, and sending are performed without a system call. Some embodiments preserve standard BSD Sockets API but provide seamless zero-copy I/O support.

Packets may sometimes come in to the receiving socket faster than the transmitting socket can send them on, causing a memory buffer to fill. If the memory buffer becomes completely full and packets continue to be received, packets would have to be discarded rather than sent. The capacity of a socket to receive packets without its buffer being overwhelmed is called a “receive window size.”

In some embodiments, when the buffer is full beyond a threshold level, the method sends an indicator of a reduced size of the receive window to the original source of the set of packets. In more severe cases, in some embodiments, when the buffer is full, the method sends an indicator to the original source of the set of packets that the receive window size is zero. In general, the buffer will be filled by the receiving socket and emptied (partially or fully) by the transmitting socket. That is, memory in the buffer will become available as the transmitting socket sends data out and releases the buffer memory that held that data. Accordingly, the method of some embodiments sends multiple indicators to the original source of the packets as the buffer fullness fluctuates. For example, when the transmitting socket empties the buffer, the method of some embodiments sends a second indicator that the receive window size is no longer zero.

In some embodiments, the set of packets is a first set of packets and the method waits for the first set of packets to be sent by the second TCP socket before allowing a second set of packets to be received by the first TCP socket. In some such embodiments, the kernel memory location identifies a set of memory pages; the method frees the memory pages with a driver completion handler after the data stored in the memory pages is sent.

The method of some embodiments receives a file from a server. The method is implemented at a client machine. The method creates a page fragment cache, including multiple page fragments, for receiving file data from the server. The method allocates page fragments from the page fragment cache to a dedicated receiving (RX) ring. The method sends a request file packet over a TCP connection to the server. The method receives multiple data packets, each data packet including a header and file data. The method stores the file data for the multiple data packets sequentially in the page fragment cache. In some embodiments, the method also stores the headers in buffers separate from the page fragment cache. Each page fragment of the page fragment cache, in some embodiments, is a particular size (e.g., 4096 bytes).

Storing the file data for each of the multiple data packets sequentially in the page fragment cache, in some embodiments, includes for each packet (i) identifying a first page fragment containing data that is immediately previous, in the data file, to the file data of the packet, (ii) determining whether the identified first page fragment includes unused storage space that is less than a size of the file data of the packet, (iii) if the identified first page fragment includes unused storage space that is less than the size of the file data of the packet, storing a first portion of the file data of the packet in the first page fragment, starting immediately after the immediately previous data, wherein the first portion of the file data is equal to a size of the unused storage space and storing a second portion of the file data of the packet in a second page fragment, starting at a start of the second page fragment, and (iv) if the identified first page fragment includes unused storage space that is not less than the size of the file data of the packet, storing the file data of the packet in the first page fragment, starting immediately after the immediately previous data.

The method of some embodiments also (i) allocates a storage space and metadata for the file on a logical block device, (ii) identifies multiple sequential page fragments of the page fragment cache, where each page fragment in the sequential page fragments includes data, from the file, immediately following the data from a previous page fragment in the sequential page fragments, and (iii) copies data from the sequential page fragments to the logical block device in order of the sequential page fragments.

In the method of some embodiments, a first received packet of the multiple data packets is checked to confirm that the first received packet includes file data. The first received packet is checked by comparing a size of a payload of the first received packet to a minimum segment size of the TCP connection, in some embodiments. Each page fragment, in some embodiments, is a contiguous set of physical memory. The page fragment cache, in some embodiments, is a contiguous set of virtual memory.

The method of some embodiments provides values from a server over a network connection. The method, for each of multiple values (i) creates a file including the value on a random access memory filing system (RAMFS), (ii) receives a request to receive the value, and (iii) sends the file via a sendfile system call. Sending the file includes sending the file with a zero-copy operation, in some embodiments. The sendfile system call is a zero-copy operation in some embodiments. The file is stored, in some embodiments, on data blocks of the RAMFS and the data blocks comprising the file are identified by an index node (Inode) of the RAMFS. The sendfile system call may be a Linux sendfile system call. The value is a value in a key-value store (KVS) or a value in a scalable database, in some embodiments.

The request, in some embodiments, includes a key of a key-value store (KVS). The key is associated with a sendfile command, for sending the file, in a match-action table, in some embodiments. The key may identify the file. The file has a filename including the key itself, in some embodiments. The file has a filename derivable from the key, in some embodiments.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description and the Drawing.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates a process that allocates memory as a shared memory pool for user-space and kernel-space processes.

FIG. 2 conceptually illustrates a process for allocating a virtual region of memory for zero-copy operations.

FIG. 3 conceptually illustrates kernel memory allocated as a virtual memory address space in a user-space.

FIG. 4 conceptually illustrates system calls using dedicated ring buffers.

FIG. 5 illustrates a zero-copy memory accessible by the user-spaces and kernel-spaces of both a guest machine and a host machine.

FIG. 6 illustrates a dedicated memory allocation I/O system operating on a multi-tenant host.

FIG. 7 conceptually illustrates a process 700 of some embodiments for allocating and de-allocating kernel memory for shared memory access with kernel-space and user-space processes.

FIG. 8 conceptually illustrates a process 800 for zero-copy TCP splicing.

FIG. 9 conceptually illustrates zero-copy TCP splicing between two kernel sockets.

FIG. 10 conceptually illustrates a process of some embodiments for receiving a file from a server.

FIG. 11 illustrates the allocation of kernel memory to an RX buffer of some embodiments.

FIG. 12A illustrates two stages of a method that receives TCP packets and store them in a receive buffer.

FIG. 12B illustrates two stages that copy file data from full page fragments and to a logical block device and clear the page fragments.

FIG. 13 conceptually illustrates a process of some embodiments for providing values from a server over a network.

FIG. 14 illustrates multiple operations in sending a file that that includes a value associated with a key in a key-value database, using a sendfile command.

FIG. 15 illustrates TCP splitting in an SD-WAN that includes two private datacenters and a managed forwarding node (MFN) implemented on a host machine of a public cloud datacenter.

FIG. 16 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Modern computers use a bifurcated structure that includes a core operating system (the kernel) and applications that access that kernel operating in a user-space. Some data is used by both the kernel and by applications in the user-space. The prior art copies the data from memory locations used by the kernel to separate memory locations used by applications of the user-space. Unlike that prior art, some embodiments provide a novel method for performing zero-copy operations using a dedicated memory allocator for I/O operations (MAIO). Zero-copy operations are operations that allow separate processes (e.g., a kernel-space process and a user-space process, two sockets in a kernel-space, etc.) to access the same data without copying the data between separate memory locations. The term “kernel-space process,” as used herein, encompasses any operation or set of operations by the kernel, whether these operations are part of a specific process or independent of any specific process.

To enable the zero-copy operations that share data between user-space processes and kernel-space processes without copying the data, the method of some embodiments provides a user-space process that maps a pool of dedicated kernel memory pages to a virtual memory address space of user-space processes. The method allocates a virtual region of the memory for zero-copy operations. The method allows access to the virtual region by both the user-space process and a kernel-space process. The MAIO system of the present invention greatly outperforms standard copying mechanism and performs at least on par and in many cases better than existing zero-copy techniques while preserving the ubiquitous BSD Sockets API.

In some embodiments, the method only allows a single user to access a particular virtual region. In some embodiments, the allocated virtual region implements a dedicated receiving (RX) ring for a network interface controller (NIC). The dedicated RX ring may be limited to a single tuple (e.g., a single combination of source IP address, source port address, destination IP address, destination port address, and protocol). The dedicated RX ring may alternately be limited to a defined group of tuples.

In the method of some embodiments, the allocated virtual region implements a dedicated transmission (TX) ring for a NIC. Similar to the case in which the virtual region implements an RX ring, the dedicated TX ring may be limited to a single tuple or a defined group of tuples.

The kernel has access to a finite amount of memory. Allocating that memory for use in zero-copy operations prevents the allocated memory from being used for other kernel functions. If too much memory is allocated, the kernel may run out of memory. Accordingly, in addition to allocating virtual memory, the user-space process of some embodiments may also de-allocate memory to free it for other kernel uses. Therefore, the user-space process of some embodiments identifies virtual memory, already allocated to zero-copy operations, to be de-allocated. In some cases, a user-space process may not de-allocate enough memory. Therefore, in some embodiments, when the amount of memory allocated by the user-space process is more than a threshold amount, the kernel-space process de-allocates at least part of the memory allocated by the user-space process. In some embodiments, either in addition to or instead of the kernel-space process de-allocating memory, when the amount of memory allocated by the user-space process is more than a threshold amount, the kernel-space process prevents the user-space process from allocating more memory.

In some embodiments, the kernel-space process is a guest kernel-space process on a guest virtual machine operating on a host machine. The method may additionally allow access to the virtual region by a user-space process of the host machine and/or a kernel-space process of the host.

Zero-copy processes can also be used for TCP splicing. Some embodiments provide a method of splicing TCP sockets on a computing device (e.g., a physical computer or a virtual computer) that processes a kernel of an operating system. The method receives a set of packets at a first TCP socket of the kernel, stores the set of packets at a kernel memory location, and sends the set of packets directly from the kernel memory location out through a second TCP socket of the kernel. In some embodiments, the receiving, storing, and sending are performed without a system call. Some embodiments preserve standard BSD Sockets API but provide seamless zero-copy I/O support.

Packets may sometimes come in to the receiving socket faster than the transmitting socket can send them on, causing a memory buffer to fill. If the memory buffer becomes completely full and packets continue to be received, packets would have to be discarded rather than sent. The capacity of a socket to receive packets without its buffer being overwhelmed is called a “receive window size.”

In some embodiments, when the buffer is full beyond a threshold level, the method sends an indicator of a reduced size of the receive window to the original source of the set of packets. In more severe cases, in some embodiments, when the buffer is full, the method sends an indicator to the original source of the set of packets that the receive window size is zero. In general, the buffer will be filled by the receiving socket and emptied (partially or fully) by the transmitting socket. That is, memory in the buffer will become available as the transmitting socket sends data out and releases the buffer memory that held that data. Accordingly, the method of some embodiments sends multiple indicators to the original source of the packets as the buffer fullness fluctuates. For example, when the transmitting socket empties the buffer, the method of some embodiments sends a second indicator that the receive window size is no longer zero.

In some embodiments, the set of packets is a first set of packets and the method waits for the first set of packets to be sent by the second TCP socket before allowing a second set of packets to be received by the first TCP socket. In some such embodiments, the kernel memory location identifies a set of memory pages; the method frees the memory pages with a driver completion handler after the data stored in the memory pages is sent.

The method of some embodiments receives a file from a server. The method is implemented at a client machine. The method creates a page fragment cache, including multiple page fragments, for receiving file data from the server. The method allocates page fragments from the page fragment cache to a dedicated receiving (RX) ring. The method sends a request file packet over a TCP connection to the server. The method receives multiple data packets, each data packet including a header and file data. The method stores the file data for the multiple data packets sequentially in the page fragment cache. In some embodiments, the method also stores the headers in buffers separate from the page fragment cache. Each page fragment of the page fragment cache, in some embodiments, is a particular size (e.g., 4096 bytes).

Storing the file data for each of the multiple data packets sequentially in the page fragment cache, in some embodiments, includes for each packet (i) identifying a first page fragment containing data that is immediately previous, in the data file, to the file data of the packet, (ii) determining whether the identified first page fragment includes unused storage space that is less than a size of the file data of the packet, (iii) if the identified first page fragment includes unused storage space that is less than the size of the file data of the packet, storing a first portion of the file data of the packet in the first page fragment, starting immediately after the immediately previous data, wherein the first portion of the file data is equal to a size of the unused storage space and storing a second portion of the file data of the packet in a second page fragment, starting at a start of the second page fragment, and (iv) if the identified first page fragment includes unused storage space that is not less than the size of the file data of the packet, storing the file data of the packet in the first page fragment, starting immediately after the immediately previous data.

The method of some embodiments also (i) allocates a storage space and metadata for the file on a logical block device, (ii) identifies multiple sequential page fragments of the page fragment cache, where each page fragment in the sequential page fragments includes data, from the file, immediately following the data from a previous page fragment in the sequential page fragments, and (iii) copies data from the sequential page fragments to the logical block device in order of the sequential page fragments. To implement these operations, the method of some embodiments uses a novel receive file command, called recvfile command. The recvfile command is a novel counterpart to existing sendfile command that is used in the Linux operating system. The recvfile sets up a location for a file on local machine, requests the file from distant machine, and allows distant machine to directly write file to the pre-set location. In some embodiments, the recvfile command is a zero-copy operation that transfers control of the received data from the socket to a process of the kernel. In other embodiments, the recvfile command is not a zero-copy operation.

The sendfile command in some embodiments is also a zero-copy operation. In some embodiments, the sendfile command is an operation of an operating system (e.g., Linux) that copies data between a first file descriptor and a second file descriptor. This copying is done within the kernel. This is in contrast to transferring data to and from a user space with read and write operations. Performing the copying within the kernel is more efficient than reading from and writing to user space, therefore, sendfile is more efficient than using read and write. The improvement over using read/write operations is particularly useful when sending a file out of the system through a socket (e.g., to a remote machine) by making using the socket file descriptor as the second file descriptor. In this case, with the sendfile command addressed to send the file to the socket, the kernel reads the datafile and sends it to the socket in a single operation.

In the method of some embodiments, a first received packet of the multiple data packets is checked to confirm that the first received packet includes file data. The first received packet is checked by comparing a size of a payload of the first received packet to a minimum segment size of the TCP connection, in some embodiments. Each page fragment, in some embodiments, is a contiguous set of physical memory. The page fragment cache, in some embodiments, is a contiguous set of virtual memory.

The method of some embodiments provides values from a server over a network connection. For each of multiple values, the method of some embodiments (i) creates a file including the value on a random access memory filing system (RAMFS), (ii) receives a request to receive the value, and (iii) sends the file via a sendfile system call. The file sent, in the method of some embodiments, is stored on data blocks of the RAMFS and the data blocks containing the file are identified by an index node (Inode) of the RAMFS. The value is a value in a key-value store (KVS) or a value in a scalable database, in some embodiments. The sendfile operation is a zero-copy operation, as mentioned above, in some embodiments. The request, in some embodiments, includes a key of a key-value store (KVS). The key is associated with a sendfile command, for sending the file, in a match-action table, in some embodiments. The key may identify the file. The file has a filename including the key itself, in some embodiments. The file has a filename derivable from the key, in some embodiments.

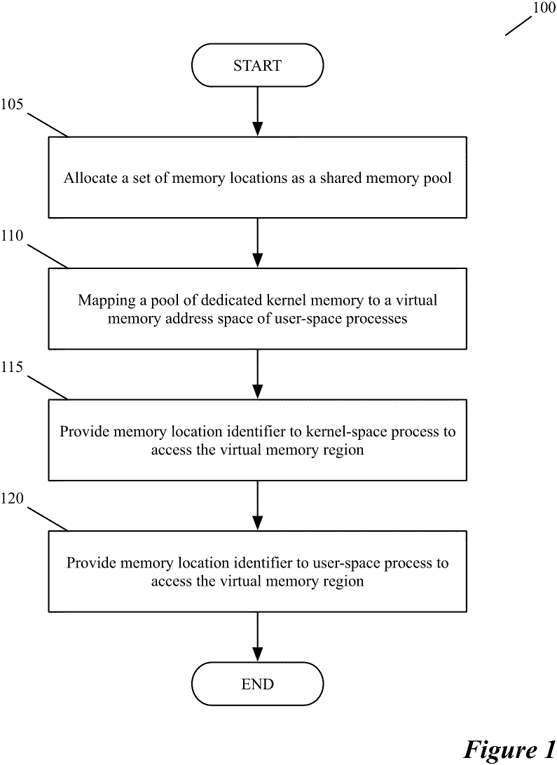

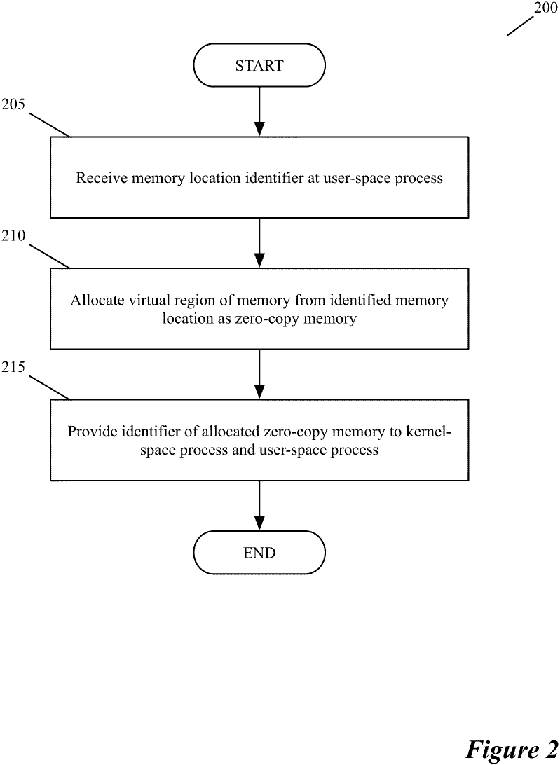

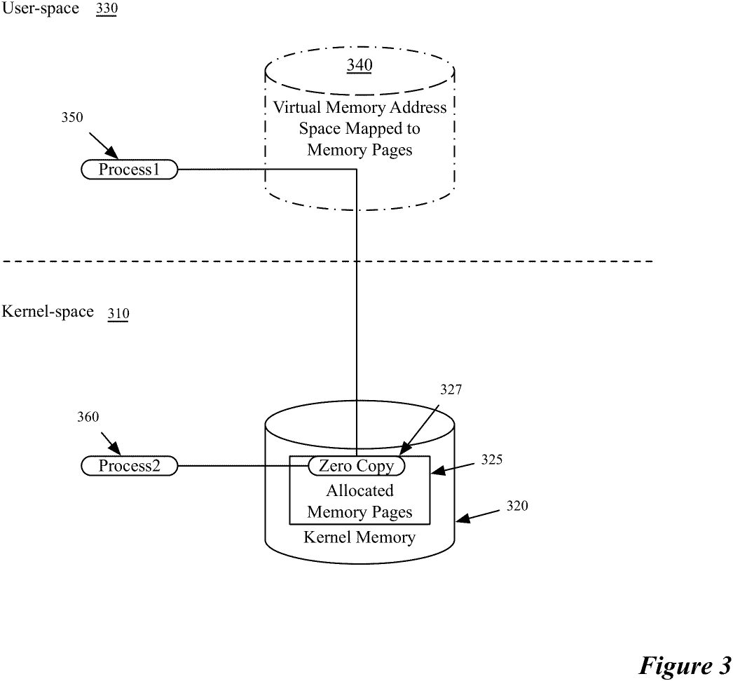

Some embodiments provide a novel method for performing zero-copy operations using dedicated memory allocated for I/O operations. FIG. 1 conceptually illustrates a process 100 that allocates memory as a shared memory pool for user-space and kernel-space processes. FIG. 2 conceptually illustrates a process 200 for allocating a virtual region of memory for zero-copy operations. The process 100 of FIG. 1 and process 200 of FIG. 2 will be described by reference to FIG. 3. FIG. 3 conceptually illustrates kernel memory allocated as a virtual memory address space in a user-space. FIG. 3 includes a kernel-space 310 with kernel memory 320 and user-space 330 with virtual memory 340. Kernel memory 320 includes allocated memory pages 325 which in turn include memory 327 allocated for zero-copy operations. A user-space process 350 runs in user-space 330 and a kernel-space process 360 runs in kernel-space 310.

The process 100 of FIG. 1 prepares memory for sharing data between user-space processes and kernel-space processes without copying the data. The method 100 allocates (at 105) a set of memory locations as a shared memory pool. In some embodiments, the memory pool is allocated from kernel memory. An example of this is shown in FIG. 3, with memory pages 325 allocated as shared memory pages. The process 100 (of FIG. 1) then maps (at 110) a pool of the dedicated kernel memory to a virtual memory address space of user-space processes. FIG. 3 illustrates such a mapping with the allocated memory pages 325 mapped to virtual memory 320. Although the embodiment of FIG. 3 shows the allocated memory pages 325 mapped to a single virtual memory space, in some embodiments the allocated memory may be mapped to multiple virtual memory address spaces (e.g., for multiple processes in a single user-space, processes in multiple user-spaces, processes owned by multiple tenants of a datacenter, etc.)

After the memory is mapped, the process 100 then provides (at 115) the memory location identifier to a kernel-space process to allow the kernel-space process to access the virtual memory region. The process 100 also provides (at 120) a memory location identifier to a user-space process to access the virtual-memory region.

Although the process 100 is shown as providing memory location identifier to the kernel-space process first, one of ordinary skill in the art will understand that other embodiments provide the memory location identifier to the kernel-space process after providing it to the user-space process. Additionally, in some embodiments, the features of either operation 115 or operation 120 may be combined with the features of operation 110 into a single operation in which the mapping operation is performed by a kernel-space operation or a user-space operation which creates the memory location identifier of operations 115 or 120 in the course of a mapping operation similar to operation 110. In some embodiments, the location identifier may supply an identifier of a memory location in kernel-space at which the memory begins and/or a corresponding memory location in a virtual memory for the user-space at which the memory begins. In embodiments in which the kernel-space and the user-space each uses a separate addressing locations for the same physical memory location, this or whatever other location identifier or identifiers are exchanged between the user-space process and the kernel allows the kernel to identify an address of a page, in the kernel-space memory, based on a supplied memory page address, in the virtual memory, provided to the kernel by the user-space process. Similarly, in some embodiments, the user-space process may translate the address locations between the virtual memory addresses and the kernel-space memory addresses.

Once the process 100 maps a pool of dedicated kernel memory pages to a virtual memory address space of user-space processes, some embodiments provide a process for allocating a virtual region of that dedicated kernel memory for zero-copy operations. FIG. 2 conceptually illustrates a process 200 for allocating a virtual region of memory for zero-copy operations. The process 200 receives (at 205) a memory location identifier of an allocated pool of memory shared by kernel-processes and user-space processes. In some embodiments, the memory location identifier is received from a user-space process or kernel-space process that allocates the memory (e.g., in operation 110 of FIG. 1).

The process 200 allocates (at 210) a virtual region of memory from the identified memory location for use in a zero-copy memory operation. The process 200 provides (at 215) an identifier of the allocated memory for zero-copy memory operations to a kernel-space process and a user-space process. In FIG. 3, the zero-copy memory is accessible by both user-space process 350 and kernel-space process 360. Although process 200 is described as being performed by a user-space process, one of ordinary skill in the art will understand that in some embodiments a kernel-space process allocates the memory for zero-copy memory operations instead of the user-space process allocating the memory. Similarly, in some embodiments, both user-space processes and kernel-space processes can allocate memory for zero-copy memory operations.

Zero-copy operations between kernel-space and user-space are useful in multiple processes. One such process is receiving and transmitting data in I/O operations. In existing systems, the direct and indirect costs of system calls impact user-space I/O performance. Some embodiments of the present invention avoid these costs by offloading the I/O operation to one or more dedicated kernel threads which will perform the I/O operation using kernel sockets rather than requiring user-space processes to perform the I/O operations. In some embodiments, a dedicated ring memory buffer (sometimes called an RX ring) is used for receiving data at a network interface controller (NIC) and a second dedicated ring memory buffer is used for transmitting data from the NIC. The dedicated RX ring may be limited to a single tuple (e.g., a single combination of source IP address, source port address, destination IP address, destination port address, and protocol). The dedicated RX ring may alternately be limited to a defined group of tuples. Similarly, in some embodiments an allocated virtual region implements a dedicated transmission ring memory buffer (sometimes called a TX ring) for a NIC. As in the case in which the virtual region implements an RX ring, the dedicated TX ring may be limited to a single tuple or a defined group of tuples.

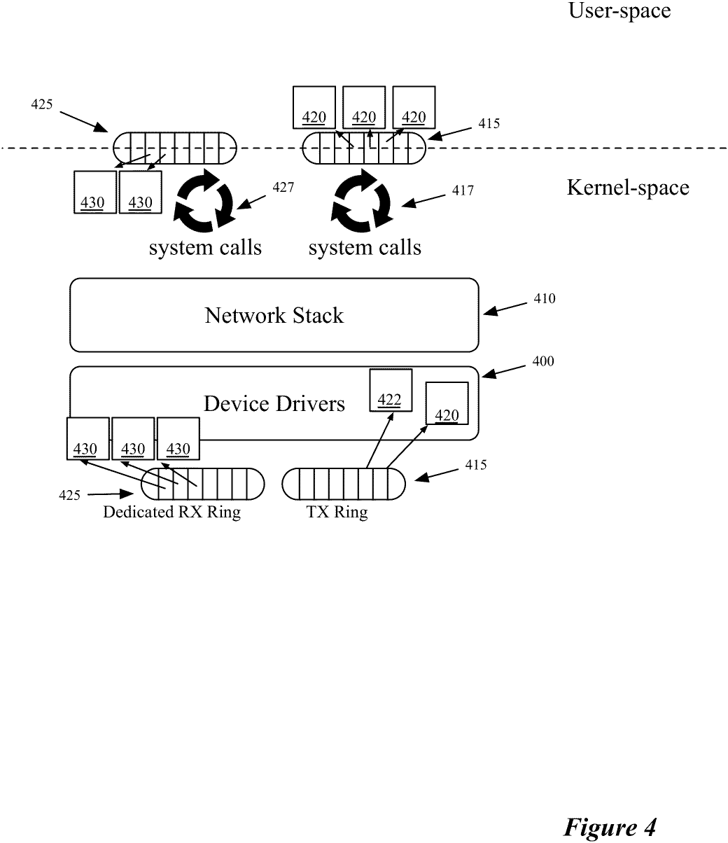

An example of such dedicated RX and TX rings is shown in FIG. 4. FIG. 4 conceptually illustrates send and receive threads using dedicated ring buffers. FIG. 4 includes device drivers 400 and a network stack 410 operating in kernel-space, dedicated transmission ring memory buffers 415 which receive data 420 from kernel system calls (i.e., system calls sending messages from the kernel to the user-space), dedicated receiving ring memory buffers 425 which transmit data 430, through kernel system calls (i.e., system calls receiving messages at the kernel from the user-space).

Although the dedicated transmission memory buffer ring 415 is shown as two separate items, one in the kernel-space and one straddling a dashed line separating user-space from kernel-space, they are the same memory buffer ring shown from two different perspectives, not two separate entities. Kernel processes and user processes each have access to the transmission memory buffer ring 415 and the data 420 sent from the kernel with system calls 417 in the user-space is all data stored in the transmission memory buffer ring 415. In addition to storing data 420 for MAIO pages, in some embodiments, the dedicated transmission ring may be used to store data 422 for a kernel buffer without needing any special care for data separation.

As with dedicated memory buffer ring 415, although the dedicated receiving memory buffer ring 425 is shown as two separate items, one in the kernel-space and one straddling a dashed line separating user-space from kernel-space, they are also a single memory buffer ring shown from two different perspectives, not two separate entities. Kernel processes and user processes each have access to the transmission memory buffer ring 425 and the data 430 received by the kernel with system calls 427 from the user-space is all data stored in the transmission memory buffer ring 425.

Some embodiments use dedicated threads with the ring buffers. This has multiple advantages. For example, it reduces the need for some system calls which would otherwise slow down the data transmission. For example, when sending data some embodiments do not require a send_msg system call, but instead use an I/O descriptor (e.g., struct, msghdr, and int flags) written to a shared memory ring buffer. Additionally, splitting (between the kernel-space process and the user-space process) responsibility for performing I/O preserves the existing socket API, facilitates exceptionless system calls, and allows for better parallel programming. Furthermore, bifurcated I/O (splitting the responsibility for performing the I/O) enables the separation of the application computations and the TCP computations to different CPU cores. In some embodiments, dedicated kernel threads are also used to perform memory operations (e.g., retrieving memory buffers back from the user).

Although the embodiment of FIG. 4 shows receiving and transmitting only through zero-copy operations, in other embodiments, both zero-copy and standard send and receive operations are supported. For example, some embodiments provide support for standard I/O operations for apps with small I/O needs (e.g., where the copying of only a small amount of data reduces or eliminates the savings from zero-copy operations). In standard mode, the sent buffer is copied to a new MAIO buffer before being sent. In some embodiments the common memory is allocated using a NIC driver. In some embodiments, the NIC driver dedicates the memory using an application device queue (ADQ). Various embodiments may map the kernel-space memory to the virtual (user-space) memory after the NIC driver dedicates the memory for user space, after the NIC driver dedicates the memory to kernel-space, or in some embodiments the NIC driver may perform the mapping of the kernel-space memory to the virtual memory as well as dedicating the memory to a user-space process using an ADQ.

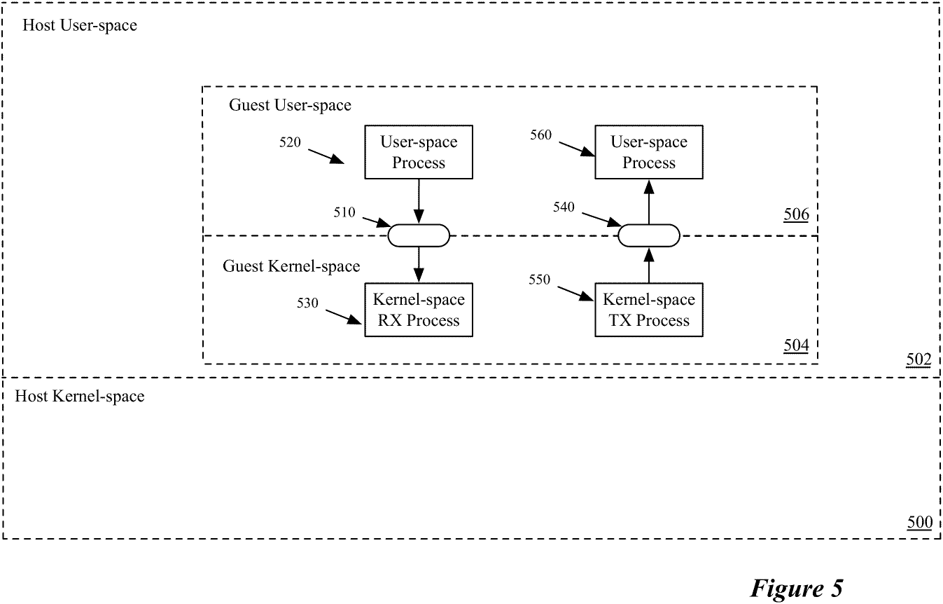

The previous figure illustrated the use of the present invention in a computer system with a single user-space and a single kernel-space. However, the invention is not limited to such systems. In some embodiments, the invention operates on a guest machine (e.g., a virtual machine operating on a physical host machine). In some such embodiments, both the host system and the guest system are designed to use zero-copy operations and are both able to access the shared memory. FIG. 5 illustrates a zero-copy memory accessible by the user-spaces and kernel-spaces of both a guest machine and a host machine. FIG. 5 includes a host kernel-space 500, a host user-space 502, a guest kernel-space 504, and a guest user-space 506. A kernel-space process 530 operates in the guest-kernel-space 504 and receives data from a user-space process 520 through a dedicated memory ring buffer 510. Similarly, another kernel-space process 550 operates in the guest-kernel-space 504 and receives data from a user-space process 560 through a dedicated memory ring buffer 540. In the embodiment of FIG. 5, both the guest user-space 506 and the guest kernel-space 504 are implemented with memory of the host user-space 502. However, in other embodiments, some or all of the memory used for the guest user-space 506 and/or the guest kernel-space 504 may be implemented with memory of the host kernel-space 500.

The example shown in FIG. 5 illustrates a guest implementation with only a single guest machine. Such an implementation eliminates security issues that might arise from exposing data from one guest machine that is owned by a first tenant, to a second data machine that is owned by a second tenant. However, even when multiple tenants have guest machines on the same host machine, some embodiments of the present invention still provide security for the tenants’ data.

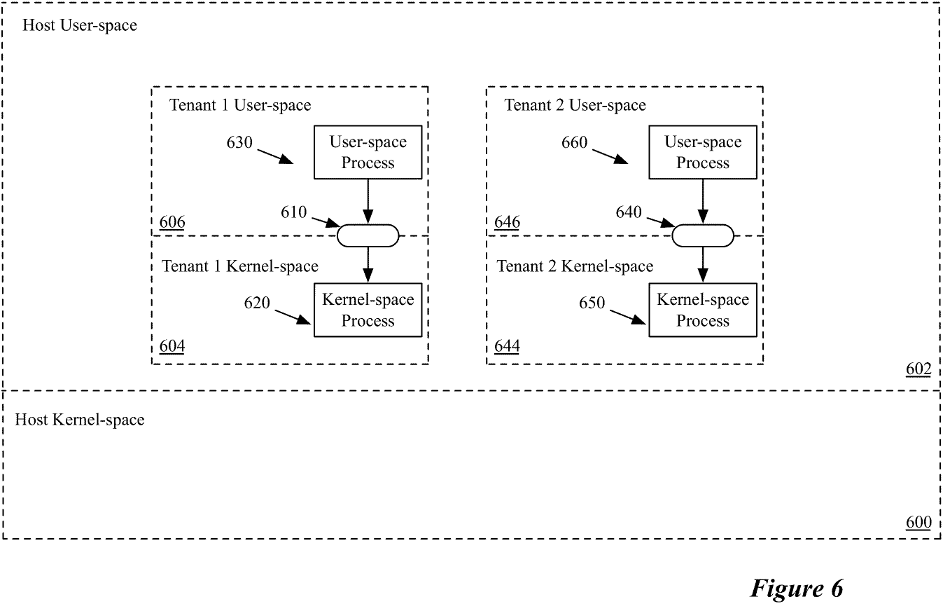

In order to protect data when user-processes now seemingly have access to sensitive guest kernel memory, the present invention provides entirely separate allocated memory to different tenants. That is, in some embodiments, the method limits access to the virtual memory region allocated for zero-copy operations to a single user. Thus, the kernel memory a particular user has access to contains only data that the particular user would normally have access to, in some embodiments. FIG. 6 illustrates a dedicated memory allocation I/O system operating on a multi-tenant host. FIG. 6 includes a host kernel-space 600 and a host user-space 602. Tenant 1 has a guest machine with a guest kernel-space 604, and a guest user-space 606. A kernel-space process 620 operates in the guest-kernel-space 604 and receives data from a user-space process 630 through a dedicated memory ring buffer 610. Tenant 2 has a guest machine with a guest kernel-space 644, and a guest user-space 646. A kernel-space process 650 operates in the guest-kernel-space 644 and receives data from a user-space process 660 through a dedicated memory ring buffer 640. Memory ring 610 is used exclusively for tenant 1, while memory ring 640 is used exclusively for tenant 2. Accordingly, no data can leak from tenant 1 to tenant 2 or vice versa through the dedicated memory ring buffers. In a similar manner to the embodiment previously described with respect to FIG. 5, in FIG. 6 both the guest user-spaces 606 and 646 and the guest kernel-spaces 604 and 644 are implemented with memory of the host user-space 602. However, in other embodiments, some or all of the memory used for the guest user-space 606 and 646 and/or the guest kernel-space 604 and 644 may be implemented with memory of the host kernel-space 600.

Some embodiments provide additional security features. For example, in some embodiments, shared pages are only ever used by the kernel to hold I/O data buffers and not any metadata or any other data needed by the kernel. That is, the user-space process can only ever see the information that a user-space process has written or data bound to user-space which would be received by the user in a standard operation, even if a zero-copy operation were not used. In some embodiments, in addition to the message data, the kernel-process is privy to transport headers as well. In some embodiments, where the NIC supports Header/Data splitting, the kernel-process places the headers onto non-shared buffers for additional security. In contrast, in embodiments where all potential receiving memory ring buffers are shared, the MAIO would potentially expose all traffic to a single observer. In the absence of driver support for keeping different tenant data separate, the usefulness of MAIO in such embodiments should be limited to those cases when any user with access is trusted (e.g., sudo).

Kernel memory allocated to zero-copy operations is not available for other kernel functions. If allocated memory is not released back to the kernel while new memory continues to be allocated, the kernel may run out of memory for those other functions. Therefore, in addition to allocating virtual memory, the user-space process of some embodiments may de-allocate memory. That is, the user-space process may identify virtual memory, previously allocated to zero-copy operations, to be de-allocated.

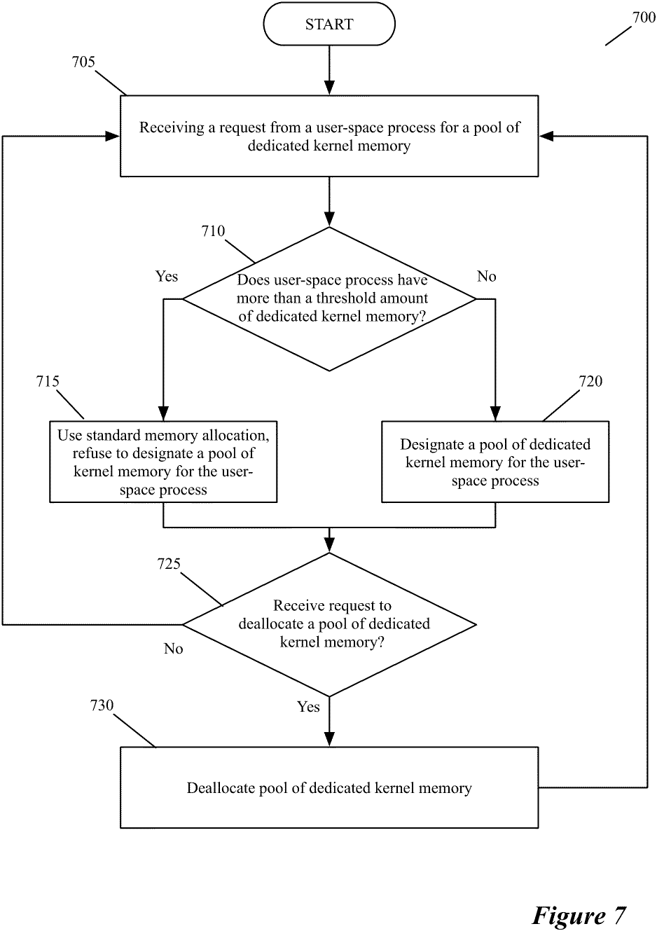

Under some circumstances, a user-process may not properly de-allocate memory. Accordingly, in some embodiments, when the amount of memory allocated by the user-space process is more than a threshold amount, the kernel-space process takes corrective action. In some embodiments, when the amount of memory allocated by the user-space process is more than a threshold amount, the kernel-space process prevents the user-space process from allocating more memory. FIG. 7 conceptually illustrates a process 700 of some embodiments for allocating and de-allocating kernel memory for shared memory access with kernel-space and user-space processes. The process 700 receives (at 705) a request from a user-space process for a pool of dedicated kernel memory to be accessed by both kernel-space and user-space processes. The process 700 determines (at 710) whether the user-space process has more than a threshold amount of kernel memory dedicated to that user-space process. In some embodiments, the threshold is a fixed amount, in other embodiments; the threshold is variable based on available (free) system resources, relative priority of various user-processes etc. In some embodiments, the threshold is determined on a per-process basis; in other embodiments, the threshold may be determined on a per guest machine basis or a per-tenant basis.

When the process 700 determines (at 710) that the user-process has more than the threshold amount of memory, the process 700 uses (at 715) a standard memory allocation (e.g., the driver of the NIC uses a standard memory allocation) and refuses to designate a pool of kernel memory for the user-space process. For example, this occurs when a user-space process hoards MAIO buffers without releasing them to the kernel, thus starving the kernel of needed memory. In some embodiments, when the driver of the NIC reverts to standard memory allocation, this renders the user-space process unable to receive, while other process and kernel functionality will remain intact. After operation 715, the process 700 moves on to operation 725.

When the process 700 determines (at 710) that the user-process does not have more than the threshold amount of memory, the process 700 designates (at 720) a pool of dedicated kernel memory for the user-space process to share with kernel-space processes. After operation 720, the process 700 moves on to operation 725.

The process 700 determines (at 725) whether it has received (e.g., from the user-space process) a request to de-allocate a pool of dedicated kernel memory. When the process 700 has received a request to de-allocate a pool of dedicated kernel memory, the process 700 de-allocates (at 730) that pool of kernel memory, freeing that pool to be allocated for shared use with other user-space processes or for use in other kernel operations. The process then returns to operation 705 when it receives a new request for a pool of memory. When the process 700 determines (at 725) that it has not received a request to de-allocate a pool of dedicated kernel memory, the process 700 returns to operation 705.

The process 700 may be used to prevent memory hoarding by a user process in circumstances when zero-copy solutions with a shared static buffer are considered dangerous because these shared pages can be exhausted and cannot be swapped out. However, some modern systems have hundreds of GB of RAM and such systems may not be exhausted during typical operation. In such systems, the user-space process might not reach a threshold level requiring the kernel to refuse further memory allocation. In other embodiments, the kernel-space process itself de-allocates memory allocated to the user-space process rather than merely denying new allocations.

Although the previous description involved zero-copy operations used between kernel-space processes and user-space processes, zero-copy processes can also be used in kernel-space to kernel-space operations. One example, of such kernel/kernel operations is TCP splicing. TCP splicing is a method of splicing two socket connections inside a kernel, so that the data relayed between the two connections can be run at near router speeds.

In older prior art, TCP splicing involved user-space processes as well as kernel-space processes. In more recent prior art, a process called an “eBPF callback” is called when a packet is received. The eBPF callback forwards the received packet to a predefined socket. However, the prior art eBPF callback is problematic due to the fact that the callback is invoked in a non-process context. That is, the eBPF callback process has no way to determine whether the predefined socket to which the callback is forwarding the packet is ready to handle a packet. Therefore, when the destination socket cannot send (e.g., due to a closed send or receive window); there is no feedback process that can tell the original sender to wait for the window to open. Without this option, the notion of “back-pressure” (narrowing a receive window to tell the system that is the original source of the packets to slow or stop transmission until the transmitting socket can send the packets that already arrived) is infeasible. Back-pressure is paramount for socket splicing where the two connected lines are of different widths.

In contrast to the prior art eBPF callback, the present invention allows backpressure in the form of feedback to the original source when the transmitting socket is not ready to receive more packets. Some embodiments provide a method of splicing TCP sockets on a computing device (e.g., a physical computer or a virtual computer) that processes a kernel of an operating system. The method receives a set of packets at a first TCP socket of the kernel, stores the set of packets at a kernel memory location, and sends the set of packets directly from the kernel memory location out through a second TCP socket of the kernel. The method provides back-pressure that prevents the original source of the packets from sending packets to the receiving socket faster than the transmitting socket of the splice can send them onward. In some embodiments, the receiving, storing, and sending are performed without a system call.

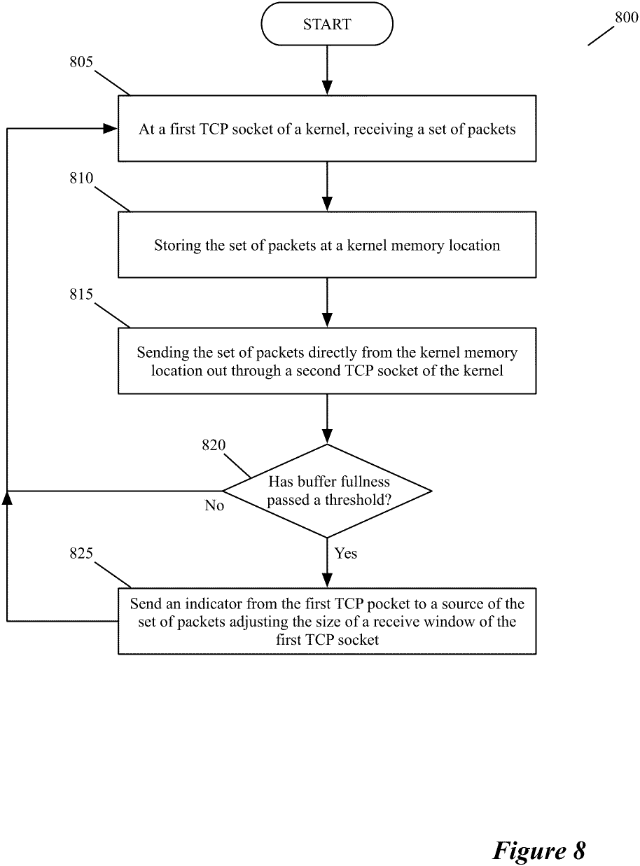

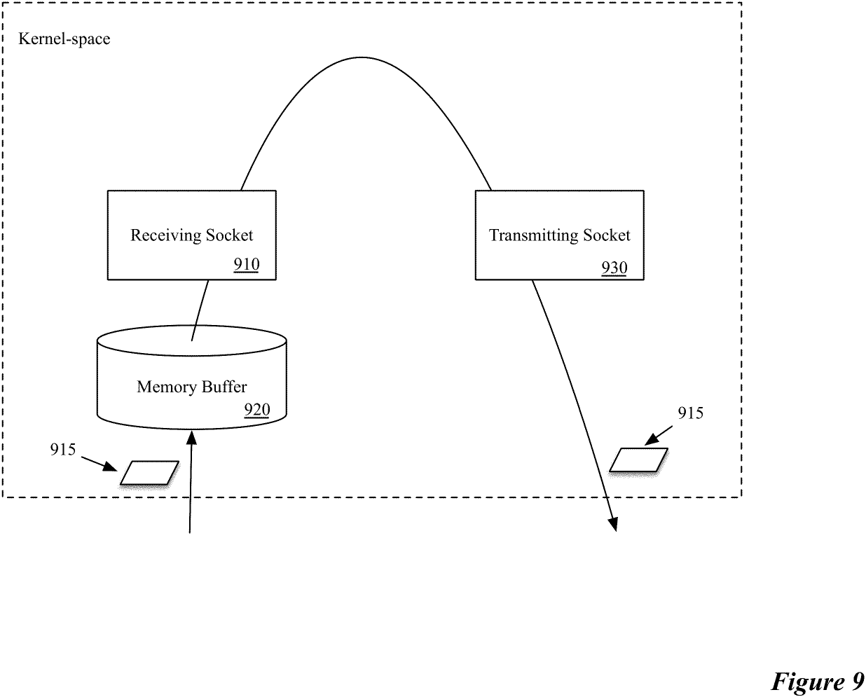

FIG. 8 conceptually illustrates a process 800 for zero-copy TCP splicing. The process 800 will be described by reference to FIG. 9 which conceptually illustrates zero-copy TCP splicing between two kernel sockets. FIG. 9 includes receiving socket 910 which receives data packets 915 and stores them in memory buffer 920 and transmitting socket 930 which transmits the data packets from the memory buffer 920 without any intermediate copying of the data.

The process 800 of FIG. 8 receives (at 805), at a first TCP socket (e.g., such as receiving socket 910 of FIG. 9) of a kernel, a set of data packets (e.g., such as data packets 915 of FIG. 9). The process 800 of FIG. 8 stores (at 810) the data packets in a kernel memory location. For example, memory buffer 920 of FIG. 9. The process 800 of FIG. 8 sends (at 815) the set of packets directly from the kernel memory location out through a second TCP socket of the kernel. For example, transmitting socket 930 of FIG. 9. In some embodiments, the kernel memory location identifies a set of memory pages of a particular set of data, and the method frees the memory pages with a driver completion handler after the data stored in the memory pages is sent (at 815).

In some cases, the transmitting socket 930 may not be able to transmit packets as quickly as the receiving socket 910 is able to receive them. When that occurs, the receiving socket 910 adds packets to the memory buffer 920 faster than the transmitting socket 930 can clear the packets by sending them. Thus, the memory buffer 920 fills up. Accordingly, the process 800 determines (at 820) whether the buffer fullness has crossed a threshold level. This can happen in one of two ways, by the fullness increasing past a first threshold or decreasing past a second threshold. One of ordinary skill in the art will understand that in some embodiments the first and second thresholds will be the same and in other embodiments the thresholds will be different.

When the buffer becomes full beyond a first threshold level, the process 800 sends (at 825) an indicator from the first TCP socket (e.g., receiving socket 910 of FIG. 9) to a source of the set of packets (not shown). The indicator communicates that the size of a receive window of the first TCP socket has been adjusted downward. After the window size is reduced the process 800 returns to operation 805 and loops through operations 805-820 until the buffer fullness passes another threshold at 820. When the original source of the packets receives such an indicator, it slows down transmission of new packets to the receiving socket 910. If this adjustment reduces the rate of receiving incoming packets below the rate that the transmitting socket, then the buffer will gradually empty while the process 800 loops through operations 805-820.

The reduction of the rate of incoming packets will eventually result in the buffer dropping below a threshold (on subsequent passes through the loop). At that point, the process 800 then sends (at 825) an indicator increasing the size of the receiving window. Once the indicator is sent, the process 800 returns to operation 805 and continues to loop through operations 805-820, occasionally returning to operation 825 to adjust the size of the receive window up or down as needed before returning to the loop again.

While the adjustments are intended to keep the packets arriving at a rate that always leaves adequate space in the buffer, in some cases, the buffer may become nearly or entirely full. In such cases, the process 800 sends (at 825) an indicator to the original source of the set of packets, that the receive window size is zero, stopping the transmission of packets to the receiving socket entirely until the transmitting socket clears enough space in the buffer. Subsequent passes through the loop send (at 815) packets, but do not receive or store new ones until the buffer has enough space to resume receiving and the process 800 sends (at 825) an indicator that the receive window is open again.

Although the above described figures disclose the elements of some embodiments, some embodiments may include other elements. For example, in some embodiments, the memory allocator uses a pool of dedicated compound memory pages (i.e., _GFP_COMP). In some embodiments, the allocator is partly based on two mechanisms: a page_frag mechanism over 64 kB buffers and these buffers in turn are allotted by a magazine allocator. This allocation scheme efficiently allocates variable size buffers in the kernel. Variable size allocation is useful to support variable sizes of MTU & HW offloads (e.g., HW GRO). To facilitate zero-copy, these pages are mapped once to the virtual memory address space of the privileged user-space process. The user-space process accesses MAIO buffers in two ways in some embodiments: (i) Zero-copy send, in which the user-space process has to mmap (mmap is a Unix system call that maps files or devices into memory), or perform a similar operation appropriate to the operating system on which the invention is implemented, the MAIO buffer and then allocate a virtual region for its own use (the allocated region’s size is a multiple of 64 kB in some embodiments); and (ii) Zero-copy receive, in which the user-space process performs a zero-copy receive operation to get MAIO buffers. The user-space process of some embodiments can return memory to the kernel via an exception-less mechanism.

With respect to Zero-copy support for kernel sockets, some embodiments expand the existing Linux TCP API with a tcp_read_sock_zcopy for RX and add a new msg flag, SOCK_KERN_ZEROCOPY, for tcp_sendmsg_locked in TX. With respect to receiving, some embodiments provide a new function, tcp_read_sock_zcopy, based on existing infrastructure i.e., tcp_read_sock. It is used by tcp_splice_read to collect buffers from a socket without copying. When kernel memory is used for I/O (e.g., for TCP socket splicing), enabling zero-copy is less complicated when compared to zero-copy from user-space. The pages are already pinned in memory and there is no need for a notification on TX completion. The pages are reference counted, and can be freed by the device driver completion handler (do_tcp_sendpages). Instead of modifying the behavior of tcp_sendmsg_locked, it is also possible to use do tcp_sendpages, which is used in splicing. Ironically, do_tcp_sendpages accepts only one page fragment (i.e., struct page, size and offset) per invocation and does not work with a scatter-gather list, which tcp_sendmsg_locked supports. Although the above description refers to TCP, one of ordinary skill in the art will understand that the inventions described herein also apply to other standards such as UDP, etc.

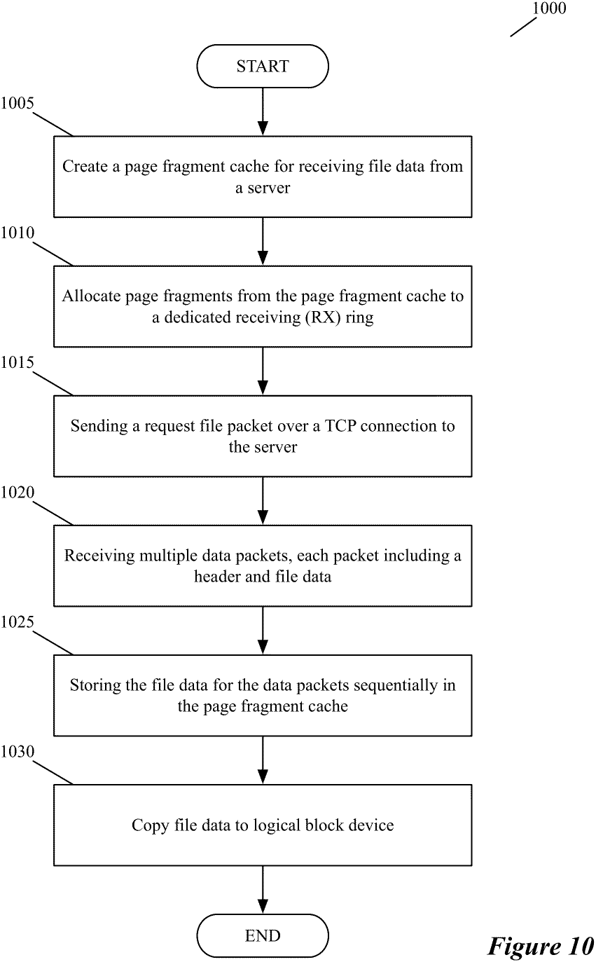

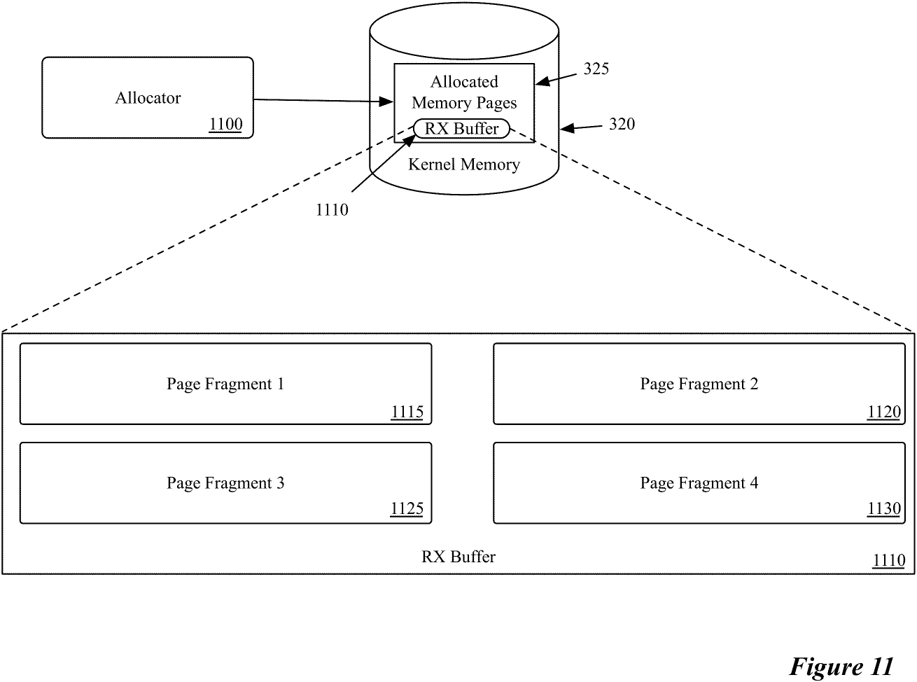

FIG. 10 conceptually illustrates a process 1000 of some embodiments for receiving a file from a server. The process 1000 creates (at 1005) a page fragment cache for receiving file data from a server. The process 1000 allocates (at 1010) page fragments from the page fragment cache to a dedicated RX ring. The page fragment cache and dedicated RX ring are further described with respect to FIG. 11, below. The process 1000 sends (at 1015) a TCP request packet over a TCP connection to the server. The TCP connection may be a connection over one or more networks (e.g., the Internet, private networks, etc.).

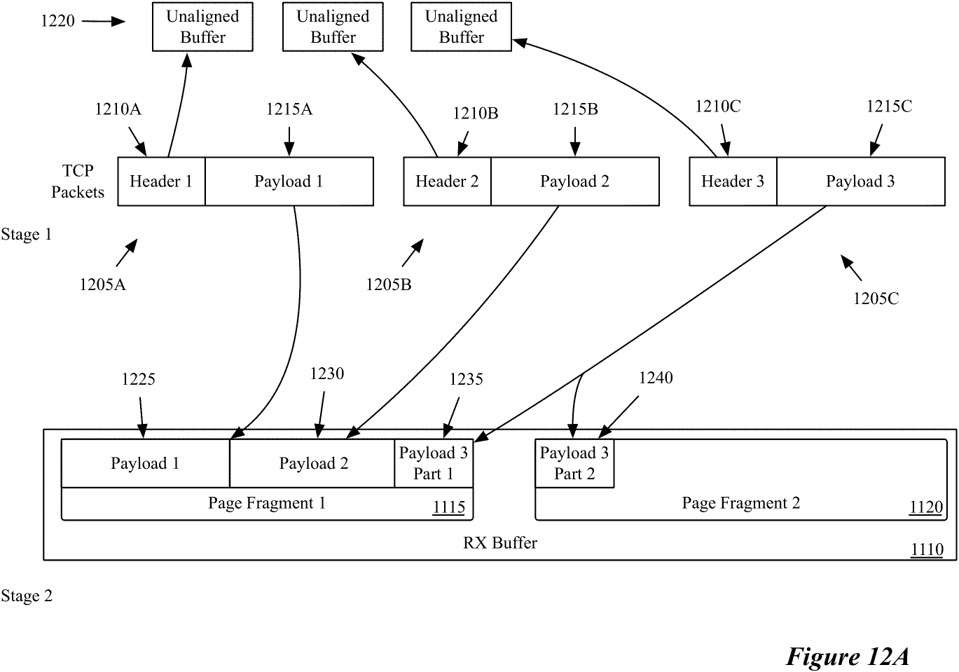

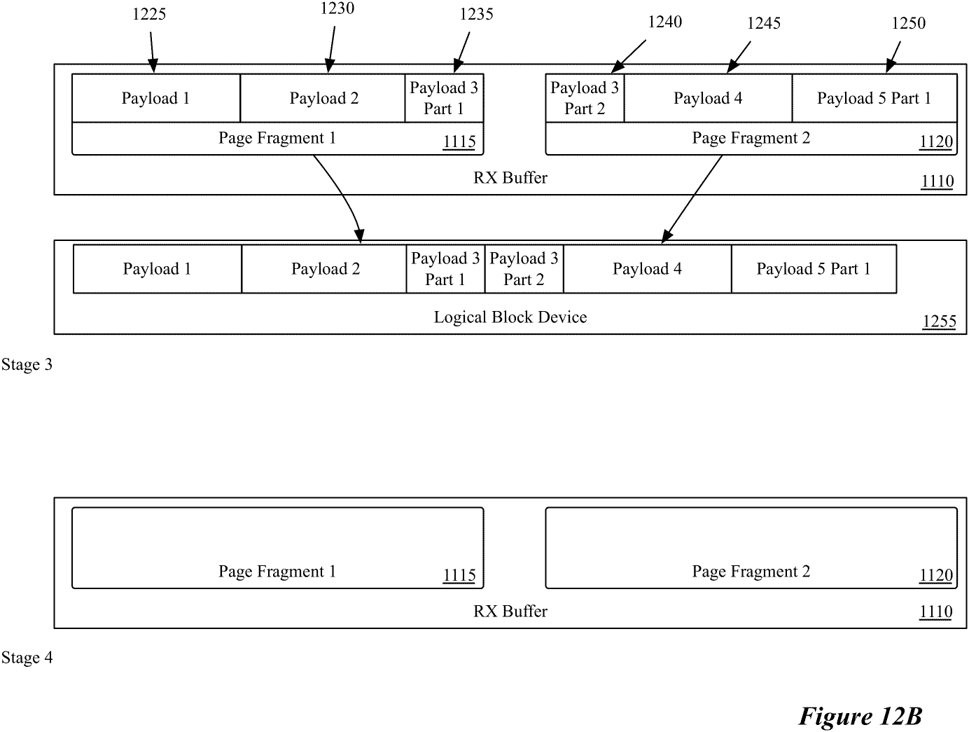

In response to the request packet, the process 1000 receives (at 1020) multiple data packets, each packet including a header and a payload of file data. One of ordinary skill in the art will understand that the payload of file data in each sequential packet is a portion of the original file data and that reassembling the payloads of all the packets in the correct order (e.g., according to packet sequence numbers in the headers of the packets) will recreate the requested file. In some embodiments, a NIC separates each packet into the header and the payload. The process 1000 then stores (at 1025) the payload (file data) sequentially in the page fragment cache. Further details of how payload data is stored sequentially in the page fragment cache are described with respect to FIG. 12A, below. In some embodiments, the process 1000 then copies (at 1030) the file data to a logical block device (e.g., a hard drive, solid state drive, thumb drive, etc.). The process 1000 then ends.

FIG. 11 illustrates the allocation of kernel memory 320 to an RX buffer 1110 of some embodiments. The allocation in some embodiments is similar to the allocation of kernel memory 320 to allocated memory pages 325 for zero-copy operations described with respect to FIG. 3 above. In some embodiments, the RX buffer 1110 is used as part of zero-copy operations. FIG. 11 includes an allocator 1100, RX buffer 1110, and page fragments 1115-1130. The allocator 1100 of some embodiments allocates page fragments (e.g., page fragments 1115-1130) to an RX buffer 1110 to be used for receiving files from a server. The RX buffer 1110 as a whole is a conceptual representation of the aggregate of the page fragments 1115-1130, rather than a separate physical entity. The allocator 1100 may be implemented as a set of software commands on a client device (not shown) such as a host computer or a virtual machine. In some embodiments, one or more page fragments may be initially allocated (e.g., fragments 1115 and 1120) with additional page fragments being allocated as needed (e.g., fragments 1125 and 1130 being allocated once fragments 1115 and 1120 are full of received data).

The page fragments 1115-1130, in some embodiments, are each a contiguous block of physical memory. In some embodiments, the page fragments are of a consistent size (e.g., 4 kB, 8 kB, 32 kB, 64 kB, etc.). Although the RX buffer in some embodiments may be part of a contiguous block of virtual memory, in general the page fragments 1115-1130 within the RX buffer 1110 are not physically contiguous with each other. That is, while the memory within each page fragment 1115, 1120, 1125, or 1130 is contiguous with the rest of the memory in that fragment 1115, 1120, 1125, or 1130, any two separate page fragments 1115, 1120, 1125, or 1130 may or may not be physically contiguous with each other. Although the illustrated embodiment allocates kernel memory, one of ordinary skill in the art will understand that other types of memory may be allocated in some embodiments.

FIGS. 12A and 12B show four stages of receiving and storing data in some embodiments. FIG. 12A illustrates two stages of a method that receives TCP packets and store them in a receive buffer. In stage 1, TCP packets 1205A-1205C are received at a client (not shown) and the headers 1210A-1210C are stored separately in unaligned buffers 1220. In some embodiments, the splitting of headers from payloads is performed in a header-data split operation of NICs (not shown). One of ordinary skill in the art will understand that header-data split is an existing operation of some NICs. In stage 2, the payloads 1215A-1215C of the TCP packets 1205A-1205C, respectively, are stored sequentially in page fragments 1115 and 1120 of RX buffer 1110. As the data are stored sequentially, each page fragment 1115 and 1120 will contain a contiguous portion of the data that comprises the requested file.

In some embodiments, the RX buffer 1110 includes page fragments of specific sizes (e.g., 4096 bytes, sometimes written as 4 kB). The specific sizes in some embodiments do not equal an exact multiple of the payload size of the TCP packets. For example, one frequently used maximum transmission unit (MTU) for TCP packets is 1500. The header of such a packet is typically in the range of a few 10s of bytes (e.g., 48 bytes) and the payload for such packets is thus approximately 1450. The 4096 bytes of a page fragment amounts to more than 2, but less than 3 full TCP packet payloads.

In order to efficiently reconstruct the original data file, there should be no gaps between the end of the file data in one page fragment and the start of the file data in the next page fragment. If there are no gaps, the data in each page fragment can simply be copied in turn to a logical block device in a later stage. However, if there is a gap in the data within a page fragment, then the exact size of the gap must be tracked and eliminated while copying the data in the page fragments to the logical block device. Accordingly, in some embodiments, when copying the payload data to the page fragment, the method determines whether a page fragment has enough unused space for the entire payload. In FIG. 12A, payloads 1215A and 1215B each fit within page fragment 1115, as payload copies 1225 and 1230, respectively. However, fragment 1115 does not have room for the entirety of payload 1215C as well as the other two payloads 1215A and 1215B. Therefore, the method splits payload 1215C up into payload partial copy 1235, which is stored as the last set of data in page fragment 1115, and payload partial copy 1240, which is stored as the first set of data in page fragment 1120.

FIG. 12B illustrates two stages that copy file data from full page fragments 1115 and 1120 to a logical block device 1225 and clear the page fragments. In stage 3, page fragment 1115 is full (with payload copies 1225 and 1230 and partial payload copy 1235). Page fragment 1120 is also full (with partial payload copy 1240, payload copy 1245, and partial payload copy 1250). As the page fragments 1115 and 1120 are full, they can be sequentially copied to a logical block device to reconstruct part of the originally requested file. Although the illustration shows a conceptual representation of the logical block device 1255 treating the data as a contiguous section of one file, one of ordinary skill in the art will understand that the logical blocks storing the file on the logical block device 1255 may be physically fragmented.

In some embodiments, the page fragment size is equal to, or a multiple of, the logical block size of the logical block device. For example, both the page fragment size and the logical block size may be 4 kB. In such embodiments, a copy operation from a page fragment to a logical block would be very efficient since there would not be a need to perform an additional write operation on the logical block device to add a small amount of data to a (possibly distant) additional logical block.

In stage 4, after the data in the page fragments 1115 and 1120 is copied to the logical block device 1255, the method of some embodiments clears the page fragments 1115 and 1120 for reuse for storing payloads of later TCP packets. In some embodiments, this stage is omitted if the RX buffer 1110 is large enough to contain the entire file. In some such embodiments, the data for the entire file is held in the RX buffer 1110 until it is all received, then copied to the logical block device 1255 and the entire RX buffer is then de-allocated to free the memory pages for subsequent use for another file or for some other purpose.

Key-value stores (KVS), (e.g., memcached, redis, Apache ZooKeeper, etc.) and scalable data bases (DB) (e.g., Casandra, MongoDB, etc.) leverage large memory tables for better performance by avoiding expensive reads from the disk storage (e.g., hard drives). But such solutions still pay a heavy price in performance when sending over the network. The cost comes mostly from copying operations performed in the course of performing the send operation.

Sending a key-value or a scalable database value happens as a response to a “read” operation. That is, a client is asking to retrieve data stored in the KVS/DB. In practical applications, read operations are more common operations than write operations (when a new key-value or database entry is stored). Therefore, the focus of this method is to provide faster read operations, at the cost of slower write operations. The method of some embodiments leverages a random access memory file system (RAMFS) for value storage.

In the prior art, hashing/memory tables store the actual value or a memory pointer to the value. In contrast, the method of some embodiments stores a file handler. The method creates a file on the RAMFS for each new value added. As a result, each new value added (each write operation), costs an additional system call and a copy. However, the benefit is that each subsequent read operation can be implemented with a sendfile system call (e.g., a zero-copy Linux sendfile system call), thus allowing for zero-copy send.

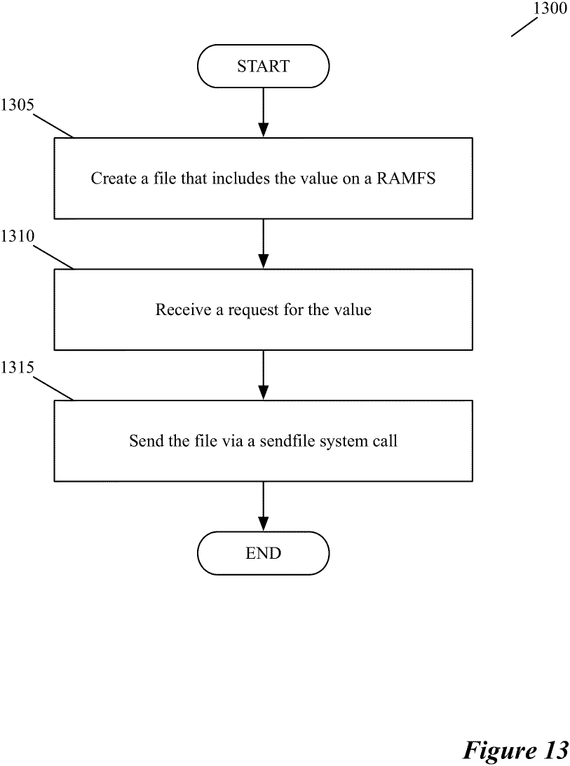

FIG. 13 conceptually illustrates a process 1300 of some embodiments for providing values from a server over a network. The process 1300 creates (at 1305) a file that includes the value in a RAMFS. In some embodiments, the value is a value in a KVS or a value in a scalable database. In some embodiments, the file includes only the value being stored and sent. In other embodiments, the file includes other values, metadata, etc. The process 1300 receives (at 1310) a request for a particular value. In some embodiments, the request is received from a machine, computer, device, etc. through a network. The process 1300 then sends (at 1315) the file to the requestor via a sendfile system call. In some embodiments the sendfile system call is a zero-copy Linux sendfile system call.

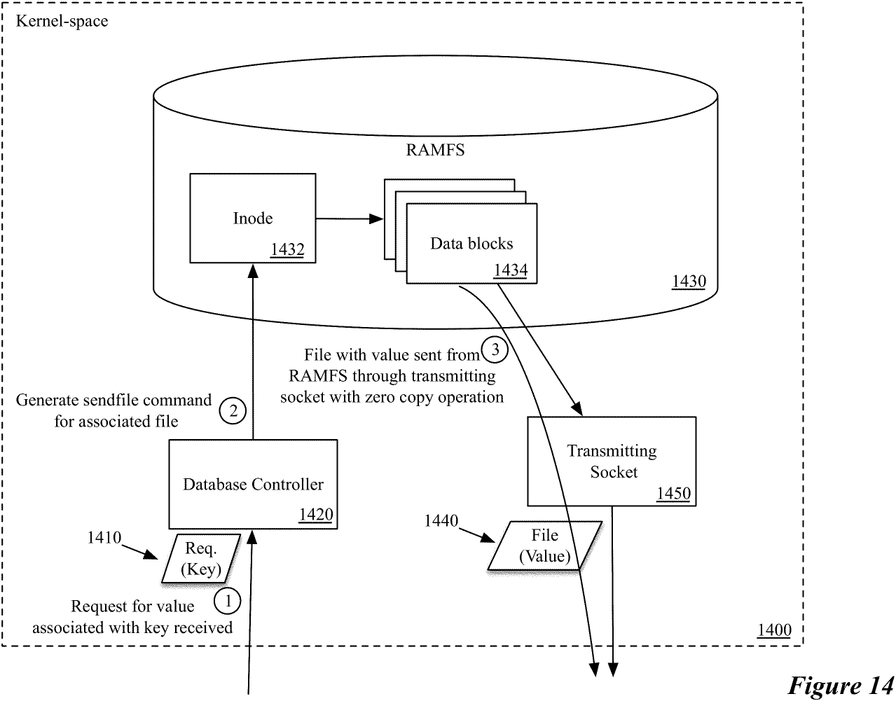

FIG. 14 illustrates multiple operations in sending a file that that includes a value associated with a key in a key-value database, using a sendfile command. First, a request 1410 is received at a kernel-space 1400 at a database controller 1420. The request 1410 includes a key to match a record in a key-value database. The key, in some embodiments, is a relatively small amount of data compared to the value. For example, in some embodiments, the key is on the order of two to sixteen bytes in size while the value is on the order of kilobytes (e.g., 4 kB). However, other embodiments use different key and/or value sizes.

In the second operation, the database controller 1420 generates a sendfile command for the file associated with the key. In some embodiments, the file may be identified by the key (e.g., the key may be a direct or indirect file identifier such as a file name or part of a file name). In other embodiments, the key may be used as a match criterion in a match-action table of the database controller in which the corresponding action is to generate a sendfile command for the specific file associated with the key. The sendfile command is implemented by the RAMFS 1430. In the illustrated embodiment, an index node (inode) 1432 identifies the specific data blocks 1434 that include the file data.

Then in the third operation, the file 1440 with the value associated with the received key is sent from the RAMFS 1430 out through a transmitting socket 1450 in a zero-copy operation. Although the illustrated embodiment includes specific elements performing the described operations, one of ordinary skill in the art will understand that in other embodiments, the actions described as being performed by multiple elements in the illustrated embodiment may be performed by a single element and actions described as being performed by a single element may be divided among multiple elements. One of ordinary skill in the art will understand that the present invention still has some computational overhead (such as generating the sendfile command, identifying the file associated with the key, etc.) however, this overhead is far less than the overhead associated with system call copy operations necessary to extract a large value from a prior art key-value table.

The previously described figures show the actions of machines that send and receive data in various zero copy operations. The routes that such data takes between the sending and receiving machines have not been described. In some embodiments, the data is routed over physical networks. However, in other embodiments, the data is routed over software defined wide area networks (SD-WANs). In some embodiments, an SD-WAN is a WAN established by configuring routers (e.g., software routers executing on host computers with other machines (VMs) of other tenants) in one or more public cloud datacenters to implement a WAN to connect one entity’s external machines that are outside of the public cloud datacenter.

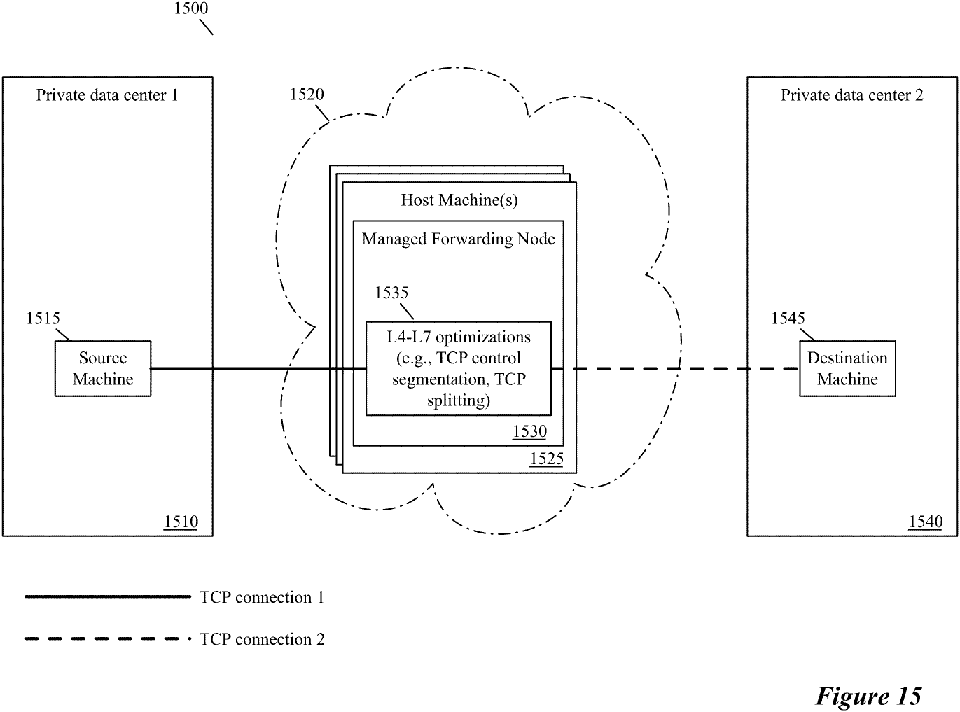

FIG. 15 illustrates TCP splitting in an SD-WAN 1500 that includes two private datacenters 1510 and 1540 and a managed forwarding node (MFN) 1530 implemented on a host machine 1525 of a public cloud datacenter 1520. The SD-WAN 1500 connects a source machine (e.g., physical or virtual machines, container(s) of a container network, etc.) in a first private datacenter 1510, through a public cloud datacenter 1520, to a destination machine 1545 in the second private datacenter 1540. The MFN 1530 is a software MFN operating on a host machine 1525 of the public cloud datacenter 1520. The MFN 1530 includes an optimization engine 1535.

The optimization engine 1535 executes processes that optimize the forwarding of the data messages from sources to destinations (here, from the source machine 1515 to the destination machine 1545) for best end-to-end performance and reliability. Some of these processes implement proprietary high-performance networking protocols, free from the current network protocol ossification. For example, in some embodiments, the optimization engine 1535 optimizes end-to-end TCP rates through intermediate TCP splitting and/or termination.

TCP splitting optimizes a TCP connection between a source and a destination by replacing the single TCP connection with multiple TCP connections, one between a splitter (e.g., MFN 1530) and the source, another between a splitter (e.g., MFN 1530) and the destination, and for routes with more than one splitter, TCP connections between each splitter and the next in the sequence between source and destination. TCP splitting is sometimes used when a single TCP connection is subject to both high round trip time (RTT) and high loss. In such cases, the TCP connection is split into multiple legs, some of which may have high RTTs, and some of which may have high loss, but preferably none of the legs have both high RTTs and high loss. As each TCP connection includes its own error and congestion controls, the separate legs of the split TCP handle the challenges of their individual legs better than the single TCP connection could handle all the challenges at once.

One of ordinary skill in the art will understand that the illustrated SD-WAN 1500 is simplified to emphasize the source machine 1515, destination machine 1545 and the optimization engine 1535 without exploring the details of elements that are well known in the art such as network interface cards (NICs), possible host machines of the private data networks 1510 and 1540 that implement the source machine 1515 and destination machine 1545, the numerous additional components of a managed forwarding node 1530, etc. Further description of SD-WANs operating on private datacenters and public clouds may be found in U.S. Pat. No. 11,005,684, which is incorporated herein by reference.

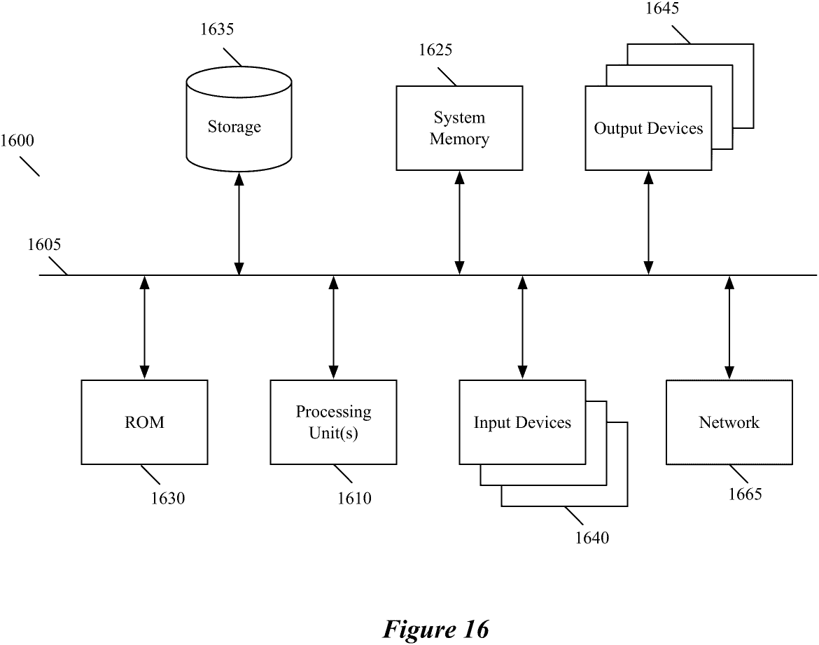

FIG. 16 conceptually illustrates an electronic system 1600 with which some embodiments of the invention are implemented. The electronic system 1600 can be used to execute any of the control, virtualization, or operating system applications described above. The electronic system 1600 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 1600 includes a bus 1605, processing unit(s) 1610, a system memory 1625, a read-only memory 1630, a permanent storage device 1635, input devices 1640, and output devices 1645.

The bus 1605 collectively represents all system, peripheral, and chipset buses that communicatively connect the numerous internal devices of the electronic system 1600. For instance, the bus 1605 communicatively connects the processing unit(s) 1610 with the read-only memory 1630, the system memory 1625, and the permanent storage device 1635.

From these various memory units, the processing unit(s) 1610 retrieve instructions to execute and data to process in order to execute the processes of the invention. The processing unit(s) may be a single processor or a multi-core processor in different embodiments.

The read-only-memory (ROM) 1630 stores static data and instructions that are needed by the processing unit(s) 1610 and other modules of the electronic system. The permanent storage device 1635, on the other hand, is a read-and-write memory device. This device is a non-volatile memory unit that stores instructions and data even when the electronic system 1600 is off. Some embodiments of the invention use a mass-storage device (such as a magnetic or optical disk and its corresponding disk drive) as the permanent storage device 1635.

Other embodiments use a removable storage device (such as a floppy disk, flash drive, etc.) as the permanent storage device. Like the permanent storage device 1635, the system memory 1625 is a read-and-write memory device. However, unlike storage device 1635, the system memory is a volatile read-and-write memory, such a random access memory. The system memory 1625 stores some of the instructions and data that the processor needs at runtime. In some embodiments, the invention’s processes are stored in the system memory 1625, the permanent storage device 1635, and/or the read-only memory 1630. From these various memory units, the processing unit(s) 1610 retrieve instructions to execute and data to process in order to execute the processes of some embodiments.

The bus 1605 also connects to the input and output devices 1640 and 1645. The input devices 1640 enable the user to communicate information and select commands to the electronic system. The input devices 1640 include alphanumeric keyboards and pointing devices (also called “cursor control devices”). The output devices 1645 display images generated by the electronic system 1600. The output devices 1645 include printers and display devices, such as cathode ray tubes (CRT) or liquid crystal displays (LCD). Some embodiments include devices such as a touchscreen that function as both input and output devices.

Finally, as shown in FIG. 16, bus 1605 also couples electronic system 1600 to a network 1665 through a network adapter (not shown). In this manner, the computer can be a part of a network of computers (such as a local area network (“LAN”), a wide area network (“WAN”), or an Intranet, or a network of networks, such as the Internet. Any or all components of electronic system 1600 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, are non-VM DCNs that include a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A method of providing values from a server over a network connection, the method comprising:
for each of a plurality of values:
creating a file comprising the value on a random access memory filing system (RAMFS);
receiving a request to receive the value; and
sending the file via a sendfile system call.

2. The method of claim 1, wherein the request comprises a key of a key-value store (KVS).

3. The method of claim 2, wherein the key is associated with a sendfile command, for sending the file, in a match-action table.

4. The method of claim 2, wherein the key identifies the file.

5. The method of claim 4, wherein the file has a filename comprising the key.

6. The method of claim 4, wherein the file has a filename derivable from the key.

7. The method of claim 1, wherein sending the file comprises sending the file with a zero-copy operation.

8. The method of claim 1, wherein the file is stored on data blocks of the RAMFS and the data blocks comprising the file are identified by an index node (Inode) of the RAMFS.

9. The method of claim 1, wherein the sendfile system call is a linux sendfile system call.

10. The method of claim 1, wherein the sendfile system call is a zero-copy operation.

11. The method of claim 1, wherein the value is a value in a key-value store (KVS).

12. The method of claim 1, wherein the value is a value in a scalable database.

13. A machine readable medium storing a program which when executed by one or more processing units provides values from a server over a network connection, the program comprising sets of instructions for:
for each of a plurality of values:
creating a file comprising the value on a random access memory filing system (RAMFS);
receiving a request to receive the value; and
sending the file via a sendfile system call.

14. The machine readable medium of claim 13, wherein the request comprises a key of a key-value store (KVS).

15. The machine readable medium of claim 14, wherein the key is associated with a sendfile command, for sending the file, in a match-action table.

16. The machine readable medium of claim 14, wherein the key identifies the file.

17. The machine readable medium of claim 13, wherein sending the file comprises sending the file with a zero-copy operation.

18. The machine readable medium of claim 13, wherein the file is stored on data blocks of the RAMFS and the data blocks comprising the file are identified by an index node (Inode) of the RAMFS.

19. The machine readable medium of claim 13, wherein the sendfile system call is a zero-copy operation.

20. The machine readable medium of claim 13, wherein the value is a value of a key-value store (KVS).
